(19) United States
(12) Patent Application Publication
(10) Pub. No.: US 2016/0341481 A1
(43) Pub. Date: Nov. 24, 2016

(54) SUBMERSIBLE HEAT EXCHANGER AND METHODS OF OPERATING AND ASSEMBLING SAME

(71) Applicant: General Electric Company, Schenectady, NY (US)

(72) Inventor: Sebastian Walter Freund, Unterfoehring (DE)

(21) Appl. No.: 14/716,210

(22) Filed: May 19, 2015

(51) Int. Cl. F28D 1/047; B23P 15/26; F28F 1/12

(52) U.S. Cl. CPC F28D 1/0477; F28F 1/126; B23P 15/26

(57) ABSTRACT

A submersible heat exchanger for transferring heat between fluid and water in an underwater environment includes a pipe having a length. The pipe includes a wall defining an interior passageway configured for fluid to flow through. A first fin is disposed on the pipe and extends from the wall in a first direction. The first fin extends in the longitudinal direction along the pipe. A second fin is disposed on the pipe and extends from the wall in a second direction different from the first direction. The second fin extends in the longitudinal direction along the pipe.

### BACKGROUND

The field of the disclosure relates generally to transferring heat using a submersible heat exchanger and, more particularly, to a natural convection heat exchanger including longitudinal fins for use in an underwater environment.

Heat exchangers are used to transfer heat between fluids and the surrounding environment. For example, oil and gas processing systems require heat exchangers to dissipate heat generated by motors, by electric inverters, or from warm process fluids. These heat exchangers are typically built as serpentine coils of pipes that transfer heat through natural convection. The heat dissipates through the outer surfaces of the pipes to the surrounding environment. However, heat exchangers require relatively large surface areas to transfer the desired amount of heat. As a result, known heat exchangers are very large and bulky. Active cooling has been employed in an effort to increase the heat transfer coefficient and, thus, reduce the size of heat exchangers. For example, water has been pumped over the pipe surfaces. However, active cooling systems are complicated and expensive to assemble and operate.

Some heat exchangers are submerged in water to transfer heat between fluid in the pipes and the water. In particular, oil and gas processing systems that are in offshore or subsea locations utilize heat exchangers submerged in water. The size of submerged heat exchangers is also dictated by the surface area necessary to dissipate heat. Additionally, the water around the submerged heat exchanger can limit the efficiency of the heat exchanger. As water removes heat from the submerged heat exchanger, the water warms. As a result, a boundary layer of warm water can surround the pipes of the submerged heat exchanger, decreasing the heat transfer efficiency. Furthermore, minerals or other deposits, e.g., scaling, can collect on the outer surfaces of heat exchangers in underwater environments. The minerals and other deposits decrease the efficiency of the submerged heat exchangers.

### BRIEF DESCRIPTION

In one aspect, a submersible heat exchanger for transferring heat between fluid and water in an underwater environment is provided. The heat exchanger includes a pipe having a length. The pipe includes a wall defining an interior passageway configured for fluid to flow through. A first fin is disposed on the pipe and extends from the wall in a first direction. The first fin extends in the longitudinal direction along the pipe. A second fin is disposed on the pipe and extends from the wall in a second direction different from the first direction. The second fin extends in the longitudinal direction along the pipe.

In another aspect, a submersible heat exchanger for dissipating heat from fluid in an underwater environment is provided. The heat exchanger includes a first set of pipe segments. The first set of pipe segments includes a first pipe segment and a second pipe segment. Each of the first pipe segment and the second pipe segment have a length and include a wall defining an interior passageway for fluid to flow through. The first pipe segment is substantially parallel to the second pipe segment. A first fin is disposed on the first pipe segment and extends from the first pipe segment wall. The first fin extends in the longitudinal direction along said first pipe segment. A second fin is disposed on the second pipe segment and extends from the second pipe segment wall. The second fin extends in the longitudinal direction along the second pipe segment. The second fin is substantially parallel to the first fin

In another aspect, a method of dissipating heat from fluid in an underwater environment using a submersible heat exchanger is provided. The method includes submerging the heat exchanger in water. The heat exchanger includes a first set of pipe segments and a second set of pipe segments. Fluid is propelled through the first set of pipe segments. Each pipe segment of the first set of pipe segments includes a first wall. Fluid is propelled through the second set of pipe segments. Each pipe segment of the second set of pipe segments includes a second wall. The first set of pipe segments and the second set of pipe segments forming a matrix of pipe segments extending in vertical and horizontal directions. Each pipe segment of the first set of pipe segments is aligned vertically in a first column and each pipe segment of the second set of pipe segments is aligned vertically in a second column. The first column is spaced apart horizontally from the second column to define a horizontal space therebetween. The method further includes transferring heat from the fluid in the first set of pipe segments to the water, transferring heat from the fluid in the second set of pipe segments to the water, and channeling heated water into the horizontal space between the first and second columns.

In a further aspect, a method of assembling a submersible heat exchanger is provided. The submersible heat exchanger defines vertical and horizontal directions. The method includes aligning a first set of pipe segments vertically in a first column and aligning a second set of pipe segments vertically in a second column. The first and second columns are spaced apart horizontally from each other to define a horizontal space therebetween. The first and second set of pipe segments are aligned horizontally in a plurality of rows. A first fin is coupled to each pipe segment of the first set of pipe segments. The first fin extends at least partially into the horizontal space between the first and second columns. A second fin is coupled to each pipe segment of the second set of pipe segments. The second fin extends at least partially into the horizontal space between the first and second columns. The method further includes coupling the first set of pipe segments and the second set of pipe segments to an inlet header and to a discharge header.

In yet another aspect, a method of transferring heat between fluid and water in an underwater environment using a submersible heat exchanger is provided. The method includes submerging the heat exchanger in the water. The heat exchanger includes a pipe including a wall, a first fin, and a second fin. The wall defines an interior passageway configured for fluid to flow through. Fluid is propelled through the pipe. The first fin contacts water to direct the water towards the pipe. The second fin contacts water to direct the water away from the pipe. Heat is transferred between the water and the fluid in the pipe through the wall.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an exemplary submersible heat exchanger;

FIG. 2 is a side view of the submersible heat exchanger shown in FIG. 1;

FIG. 3 is a front view of the submersible heat exchanger shown in FIG. 1;

FIG. 4 is a perspective view of a pipe segment suitable for use in the submersible heat exchanger of FIG. 1;

FIG. 5 is a cross-sectional view of the pipe segment shown in FIG. 4 taken along section line 5-5; and

FIG. 6 illustrates water flow past an exemplary submersible heat exchanger with longitudinal fins.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The methods and systems described herein overcome at least some disadvantages of known submersible heat exchangers by including pipes and fins that more efficiently dissipate heat to water surrounding the heat exchanger. In the exemplary embodiment, a matrix arrangement of the pipes in rows and columns facilitates the efficient flow of water past the heat exchanger. The fins extending from the pipes of the heat exchanger increase the surface area per unit length of the pipes. As a result, smaller pipes with the fins have the same surface area as larger pipes that are bare, which facilitates the smaller pipes dissipating the same amount of heat as the larger pipes. Additionally, the fins channel seawater over surfaces of the pipes and disrupt boundary layers that would form around bare pipes. The fins extend longitudinally along the pipes at angles that inhibit the collection of materials on the pipes and promote convection currents. As a result, exemplary heat exchangers have a reduced size while operating with improved effectiveness.

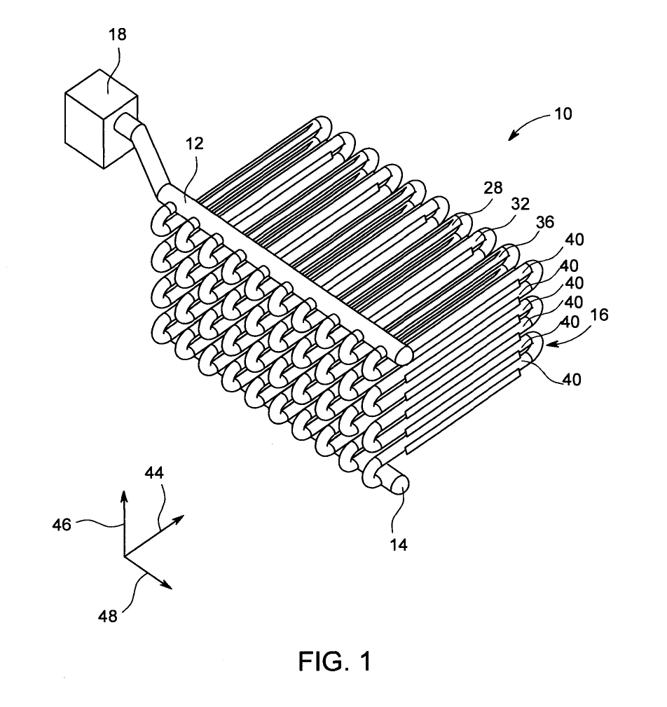

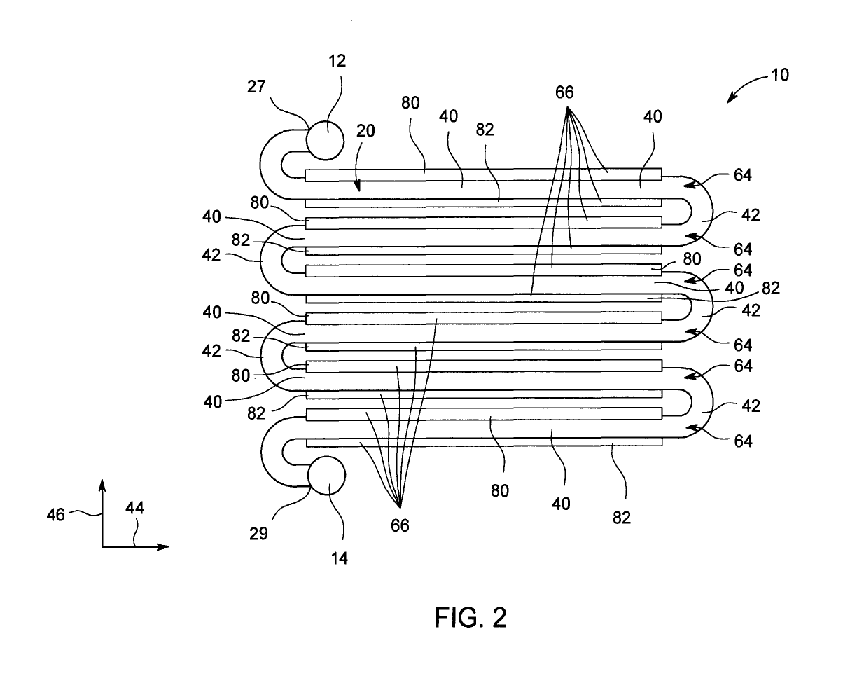

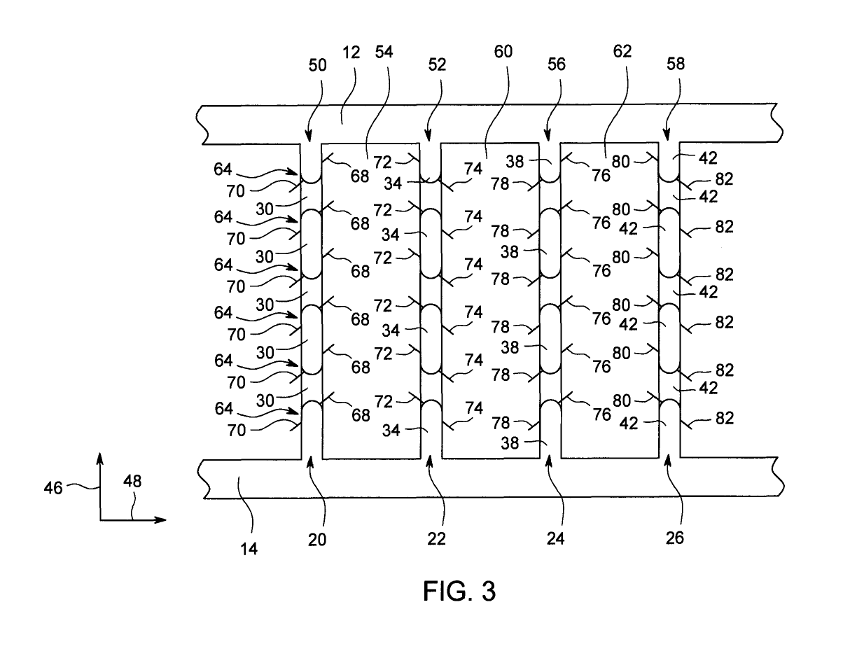

FIG. 1 is a perspective view of an exemplary submersible heat exchanger 10. FIG. 2 is a side view of heat exchanger 10 and FIG. 3 is a front view of heat exchanger 10. In the exemplary embodiment, heat exchanger 10 includes an inlet header 12, a discharge header 14, pipes 16, and a pump 18 for pumping fluid through pipes 16. Pump 18 is rotatably coupled to and powered by an electric motor (not shown). Heat exchanger 10 is used to transfer heat between fluid in pipes 16 and the surrounding environment. For example, pump 18 pumps process fluids or a coolant through pipes 16 for dissipating heat generated by devices (not shown) coupled to heat exchanger 10, e.g., without limitation, motors and electric inverters. In alternative embodiments, heat exchanger 10 uses any fluid, in liquid or gaseous states, suitable for transferring heat to or from the surrounding environment. For example, in alternative embodiments, heat exchanger 10 utilizes natural gas, methane, hydrocarbons, oxygen, Freon, carbon dioxide, water, alcohols, glycols, nitrogen, brines, oils, and combinations thereof. In the exemplary embodiment, an aqueous glycol solution coolant is pumped through pipes 16.

In the exemplary embodiment, pipes 16 include a first pipe 20, a second pipe 22, a third pipe 24, and a fourth pipe 26 each coupled to inlet header 12 and discharge header 14. An inlet 27 of each of first pipe 20, second pipe 22, third pipe 24, and fourth pipe 26 is coupled to inlet header 12 and an outlet 29 of each of first pipe 20, second pipe 22, third pipe 24, and fourth pipe 26 is coupled to discharge header 14. First pipe 20 includes a plurality of first pipe segments 28 coupled in a serpentine configuration by bends 30. Likewise, second pipe 22 includes a plurality of second pipe segments 32 coupled in a serpentine configuration by bends 34, third pipe 24 includes a plurality of third pipe segments 36 coupled in a serpentine configuration by bends 38, and fourth pipe 26 includes a plurality of fourth pipe segments 40 coupled in a serpentine configuration by bends 42. In alternative embodiments, heat exchanger 10 includes any number of pipes having any number of pipe segments 28, 32, 36, 40 coupled in any manner suitable to enable heat exchanger 10 to function as described herein.

In the exemplary embodiment, pipe segments 28, 32, 36, 40 extend in a longitudinal direction 44 between bends 30, 34, 38, 42. Specifically, pipe segments 28, 32, 36, 40 are substantially straight sections and are substantially parallel with each other in longitudinal direction 44. In alternative embodiments, pipe segments 28, 32, 36, 40 have any shape and are oriented in any direction in relation to each other.

As best seen in FIGS. 1-3, pipe segments 28, 32, 36, 40 form a matrix of pipe segments aligned in a vertical direction 46 and a horizontal direction 48. Each first pipe segment 28 is vertically aligned in a first column 50 and each second pipe segment 32 is vertically aligned in a second column 52. First column 50 and second column 52 are spaced apart horizontally to define a horizontal space 54 therebetween. Additionally, each third pipe segment 36 is vertically aligned in a third column 56 and each fourth pipe segment 40 is vertically aligned in a fourth column 58. Fourth column 58 is spaced apart horizontally from third column 56 to define a horizontal space 60 therebetween. Additionally, second column 52 and third column 56 define a middle horizontal space 62 therebetween. In alternative embodiments, pipe segments 28, 32, 36, 40 are aligned in any number of columns having any spacing therebetween. Alternatively, at least some of pipe segments 28, 32, 36, 40 are aligned other than in columns, e.g., in a helix configuration.

Additionally, in the exemplary embodiment, pipe segments 28, 32, 36, 40 are aligned in horizontal direction 48 to form rows 64. Each pipe segment 28, 32, 36, 40 is horizontally aligned with pipe segments 28, 32, 36, 40 in the same row 64 and in different columns 50, 52, 56, 58. In the exemplary embodiment, pipe segments 28, 32, 36, 40 are arranged in six of rows 64. In some embodiments, heat exchanger 10 has any number of rows 64. In further alternative embodiments, some pipe segments 28, 32, 36, 40 are not aligned in rows 64.

Each pipe segment 28, 32, 36, 40 has fins 66 configured to direct water past heat exchanger 10. In addition to directing water, fins 66 provide surface area for heat exchange, which increases the heat transfer rate of heat exchanger 10. In some embodiments, fins 66 approximately double the surface area per unit length of pipe segments 28, 32, 36, 40 and heat exchanger 10 has any number of fins 66 of any size that enable heat exchanger 10 to function as described herein. In further embodiments, heat exchanger 10 includes some pipe segments 28, 32, 36, 40 without fins 66. In the exemplary embodiment, each first pipe segment 28 has a first upper fin 68 and a first lower fin 70, each second pipe segment 32 has a second upper fin 72 and a second lower fin 74, each third pipe segment 36 has a third upper fin 76 and a third lower fin 78, and each fourth pipe segment 40 has a fourth upper fin 80 and a fourth lower fin 82. In the exemplary embodiment, some fins 66 extend into horizontal spaces 54, 60, 62. Specifically, first upper fins 68 and second upper fins 72 extend into horizontal space 54, second lower fins 74 and third lower fins 78 extend into middle horizontal space 62, and third upper fins 76 and fourth upper fins 80 extend into horizontal space 60. First lower fins 70 and fourth lower fins 82 extend away from horizontal spaces 54, 60, 62. In alternative embodiments, any of fins 66 extend toward or away from horizontal spaces 54, 60, 62.

Due to the alignment of pipe segments 28, 32, 36, 40 and the configuration of fins 66, some of fins 66 are parallel. For example, first upper fins 68 are substantially parallel to third upper fins 76 and first lower fins 70 are substantially parallel to third lower fins 78. Second upper fins 72 are substantially parallel to fourth upper fins 80 and second lower fins 74 are substantially parallel to fourth lower fins 82. In alternative embodiments, all of fins 66 are substantially parallel to each other. In further alternative embodiments, some of fins 66 are not substantially parallel to each other.

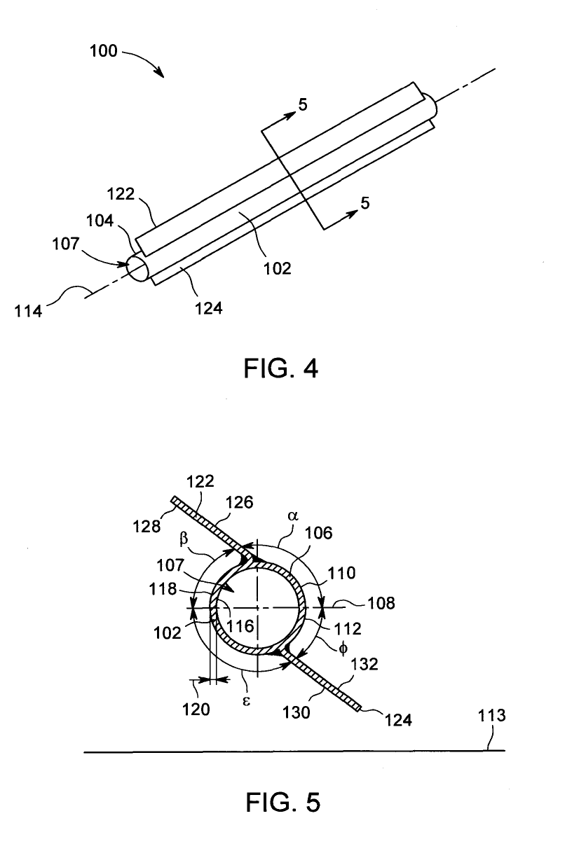

FIG. 4 is a perspective view of a pipe segment 100 suitable for use in heat exchanger 10. FIG. 5 is a cross-sectional view of pipe segment 100 taken along section line 5-5. In the exemplary embodiment, pipe segment 100 includes a wall 102 forming a cylinder 104 having a substantially circular cross section 106. Wall 102 defines an interior passageway 107 for fluid to flow through. A plane 108 bisects cylinder 104 to define an upper semi-cylinder 110 and a lower semi-cylinder 112. As shown in FIG. 5, pipe segment 100 is oriented such that upper semi-cylinder 110 is above lower semi-cylinder 112. Plane 108 passes through a longitudinal axis 114 of cylinder 104 perpendicular to circular cross section 106. Accordingly, upper semi-cylinder 110 and lower semi-cylinder 112 are substantially equal halves of cylinder 104. Wall 102 has an inner surface 116, an outer surface 118, and a thickness 120 defined between inner surface 116 and outer surface 118. When fluid flows through pipe segment 100, the fluid and wall 102 exchange heat. For example, when pipe segment 100 is submerged in cool water and a warmed fluid flows through pipe segment 100, heat from the fluid transfers to inner surface 116. From inner surface 116, heat is conducted through thickness 120 and dissipates into the water through outer surface 118. Accordingly, outer surface 118, in particular the surface area of outer surface 118, limits the amount of heat dissipated through wall 102.

A first fin 122 and a second fin 124 extend from outer surface 118 of pipe segment 100 at least partly radially in relation to cylinder 104. In the exemplary embodiment, first fin 122 and second fin 124 are longitudinal fins, i.e., first fin 122 and second fin 124 extend along wall 102 in a direction parallel to longitudinal axis 114. In the illustrated embodiment, first fin 122 and second fin 124 continuously extend along substantially the entire length of pipe segment 100. In alternative embodiments, one or both of first fin 122 and second fin 124 include one or more segments extending along a portion of the length of pipe segment 100.

First fin 122 and second fin 124 are made of any materials suitable to enable heat exchanger 10 to function as described herein. In alternative embodiments, first fin 122 and second fin 124 are any plastics, metals, ceramics, composites, and other materials suitable to enable first fin 122 and second fin 124 to function as described herein. In the exemplary embodiment, first fin 122 and second fin 124 are sheet metal strips welded to pipe segment 100. In some embodiments, first fin 122 and second fin 124 are coupled to pipe segment 100 in any manner suitable to enable first fin 122 and second fin 124 to function as described herein. In one embodiment, at least one of first fin 122 and second fin 124 is coupled to pipe segment 100 using welds, solder, mechanical fasteners, adhesives, and any other suitable coupling means that enable first fin 122 and second fin 124 to function as described herein. In further embodiments, at least one of first fin 122 and second fin 124 is integrally formed with wall 102. In the illustrated embodiment, first fin 122 and second fin 124 are substantially rectangular. In some embodiments, first fin 122 and second fin 124 are any shape suitable to function as described herein.

First fin 122 and second fin 124 facilitate heat transfer by increasing the surface area of pipe segment 100. First fin 122 has an upper surface 126 and an opposed bottom surface 128. As used herein, upper and bottom refer to the orientation of pipe segment 100 shown in FIG. 4. Upper surface 126 and bottom surface 128 direct water away from outer surface 118 of wall 102. Likewise, second fin 124 has an upper surface 132 and an opposed bottom surface 130. Upper surface 132 and bottom surface 130 direct water towards outer surface 118 of wall 102. As first fin 122 and second fin 124 contact moving water, water will transfer heat to or receive heat from first fin 122 and second fin 124. For example, when first fin 122 and second fin 124 are warmer than the surrounding water heat will be transferred from the warm surfaces of the fins into the cooler water. Accordingly, first fin 122 and second fin 124 direct water around pipe segment 100 and facilitate heat transfer between fluid flowing through pipe segment 100 and water surrounding pipe segment 100.

In the example embodiment, first fin 122 extends from upper semi-cylinder 110 and second fin 124 extends from lower semi-cylinder 112. Upper surface 126 and plane 108 make an angle α and bottom surface 128 and plane 108 make an angle β. Additionally, outer surface 118 and plane 108 make an angle ε and upper surface 132 and plane make an angle φ. In alternative embodiments, angles α, β, ε, φ are any values that enable operation of first fin 122 and second fin 124 as described herein. Preferably, angles α, β, ε, φ are between about 0° and about 180°. In the exemplary embodiment, each angle β and φ is approximately 45°. In addition, first fin 122 is positioned on wall 102 such that upper surface 126 is substantially tangential to outer surface 118. As a result, angle α and the position of first fin 122 inhibit sediment collecting on first fin 122 and wall 102 when pipe segment 100 is orientated as shown in FIG. 5 in relation to water bottom 113 due to gravity acting in a vertical direction. In contrast, bottom surface 130 is substantially non-tangential with outer surface 118, i.e., second fin 124 protrudes in a substantially radial direction from wall 102, which facilitates convective water current flowing around wall 102 when pipe segment 100 is orientated as shown in FIG. 5 in relation to water bottom 113. In some embodiments, pipe segment 100, first fin 122, and second fin 124 are coated in a protective substance to further inhibit marine growth and biofouling. In further embodiments, pipe segment 100, first fin 122, and second fin 124 have a surface finish that mitigates sedimentation and scaling.

In reference to FIGS. 1-5, a method of dissipating heat from fluid in an underwater environment using a submersible heat exchanger includes propelling fluid through first pipe segments 28. Each first pipe segment 28 includes wall 102 having a cylindrical shape. The method further includes propelling fluid through second pipe segments 32. Each second pipe segment 32 includes wall 102 having a cylindrical shape. First pipe segments 28 and second pipe segments 32 form a matrix of pipe segments aligned in vertical direction 46 and horizontal direction 48. Each first pipe segment 28 is aligned vertically in first column 50 and each second pipe segment 32 is aligned vertically in second column 52. First column 50 and second column 52 are spaced apart horizontally to define a horizontal space 54 therebetween.

The method further includes transferring heat from the fluid in first pipe segments 28 and second pipe segments 32 to the water. Additionally, the method includes channeling heated water into horizontal space 54 between first and second columns 50, 52. In the method, the heated water is channeled by contacting heated water with first upper fin 68 extending from upper semi-cylinder 110 of first pipe segment 28 and second upper fin 72 extending from upper semi-cylinder 110 of second pipe segment 32. In some embodiments, the method includes contacting water with first lower fin 70 extending from lower semi-cylinder 112 of first pipe segment 28 and, thereby, heating the water and directing a portion of the water towards first pipe segment 28 as the water rises due to natural convection.

In reference to FIGS. 1-5, a method of assembling a submersible heat exchanger 10 includes aligning first pipe segments 28 vertically in first column 50, aligning second pipe segments 32 vertically in second column 52, and aligning first and second pipe segments 28, 32 horizontally in rows 64. First and second columns 50, 52 are spaced apart horizontally from each other to define horizontal space 54 therebetween. The method further includes coupling fin 66 to each first pipe segment 28 and coupling fin 66 to each second pipe segment 32. Fins 66 coupled to first pipe segment 28 extend at least partially into horizontal space 54 between first and second columns 50, 52. Fins 66 coupled to second pipe segment 32 extend at least partially into horizontal space 54 between first and second columns 50, 52. The method further includes coupling first pipe segments 28 and second pipe segments 32 to inlet header 12 and to discharge header 14. In some embodiments, the method includes coupling another fin 66 to each first pipe segment 28 and coupling another fin 66 to each second pipe segment 32. At least one fin 66 coupled to first pipe segment 28 extends generally away from second column 52 and at least one fin 66 coupled to second pipe segment 32 extends generally away from first column 50. In the exemplary embodiment of the method, fins 66 are longitudinal fins that are oriented such that the longest dimension of fins 66 is parallel to the longitudinal direction of pipe segments 28, 32.

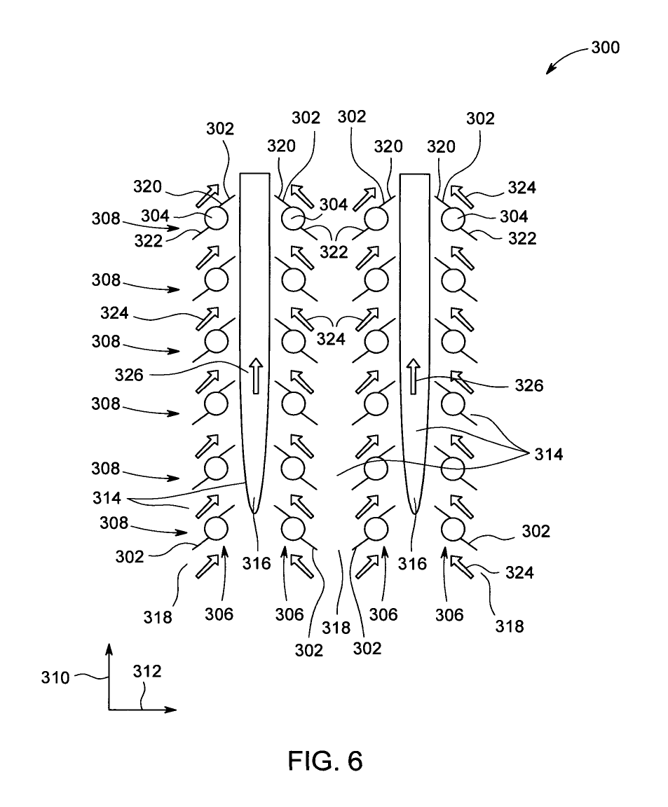

FIG. 6 illustrates water flow past an exemplary submersible heat exchanger 300 with longitudinal fins 302. Heat exchanger 300 includes a plurality of pipe segments 304 arranged in columns 306 and rows 308. Columns 306 extend in a vertical direction 310 and rows 308 extend in a horizontal direction 312. Pipe segments 304 are aligned vertically in columns 306 and spaced apart horizontally. Pipe segments 304 are aligned horizontally in rows 308 and spaced apart vertically. Columns 306 are spaced apart a horizontal distance to define a plurality of horizontal spaces that form channels 314. Channels 314 include warmed water channels 316 and cool water channels 318.

Fins 302 extend at least partly into channels 314. Fins 302 include upper fins 320 and lower fins 322. Upper fins 320 extend into warmed water channels 316 and lower fins 322 extend into cool water channels 318. In some embodiments, heat exchanger 300 has any number of fins extending into any number of channels at any angles. In the illustrated embodiment, all of fins 302 are orientated at approximately 45° relative to horizontal direction 312.

As warm fluid flows through pipe segments 304, pipe segments 304 dissipate heat to water around heat exchanger 300. Due to natural convection, the warmed water rises in vertical direction 310. Typically, warmed water surrounds bare pipe segments (not shown) forming a boundary layer, i.e., dead zone, that reduces the heat transfer efficiency of the bare pipe segments. In the exemplary embodiment, fins 302 inhibit the formation of such boundary layers around pipe segments 304. As shown by arrows 324, lower fins 322 direct water in cool water channels 318 towards pipe segments 304. As shown by arrows 326, upper fins 320 direct warmed water away from pipe segments 304 into warmed water channels 316. A greater temperature difference between fluids results in a larger heat transfer coefficient. In the exemplary embodiment, fluid in pipe segments 304 is closer to the temperature of the water in warmed water channels 316 than water in cool water channels 318. Therefore, fins 302 increase the heat transfer coefficient of heat exchanger 300 by directing cooler water towards pipe segments 304 and warmed water away from pipe segments 304. Additionally, fins 302 facilitate heat transfer between pipe segments 304 and water by providing additional surface area for pipe segments 304.

The finned pipes and their associated systems described herein provide for enhanced submersible heat exchangers that are suitable for use in an underwater environment. The fins efficiently direct water past the heat exchanger to dissipate heat from a fluid flowing through pipe segments of the heat exchanger. The pipe segments are arranged in a matrix configuration defining channels for water to flow past the heat exchanger.

The above-described heat exchanger overcomes at least some disadvantages of known heat exchangers by providing a heat exchanger with a fin that increases the heat transfer coefficient of the heat exchanger and more efficiently directs fluid, such as seawater, past the heat exchanger. Therefore, the heat exchanger with a fin has a reduced size. The reduced size of the heat exchanger will reduce material used to produce the heat exchanger and simplify assembly. Additionally, inlet and discharge headers of the heat exchanger have a reduced size to improve internal flow distribution. Moreover, the heat exchanger described herein diminishes the pressure losses of known heat exchangers.

An exemplary technical effect of the methods, systems, and apparatus described herein includes at least one of: (a) increasing the heat transfer coefficient of a portion of heat exchanger; (b) decreasing the size of heat exchangers; (c) increasing the effectiveness of heat exchangers; (e) reducing the deposition of fouling or otherwise undesirable materials on heat exchangers; and (f) reducing pressure losses in heat exchangers.

Exemplary embodiments of apparatus and methods for operating an undersea heat exchanger are described above in detail. The methods and apparatus are not limited to the specific embodiments described herein, but rather, components of systems and/or steps of the methods may be utilized independently and separately from other components and/or steps described herein. For example, the methods, systems, and apparatus may also be used in combination with other heat exchanger systems, and the associated methods, and are not limited to practice with only the systems and methods as described herein. Rather, the exemplary embodiment can be implemented and utilized in connection with many other applications, equipment, and systems that may benefit from improved heat transfer.

Although specific features of various embodiments of the disclosure may be shown in some drawings and not in others, this is for convenience only. Moreover, references to “one embodiment” in the above description are not intended to be interpreted as excluding the existence of additional embodiments that also incorporate the recited features. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A submersible heat exchanger for transferring heat between fluid and water in an underwater environment, said heat exchanger comprising:
a pipe having a length and comprising a wall defining an interior passageway configured for fluid to flow through;
a first fin disposed on said pipe and extending from said wall in a first direction, said first fin extending in the longitudinal direction along said pipe; and
a second fin disposed on said pipe and extending from said wall in a second direction different from said first direction, said second fin extending in the longitudinal direction along said pipe.

2. The heat exchanger in accordance with claim 1, wherein said wall forms a cylinder having a substantially circular cross section, a plane bisecting said cylinder to define an upper semi-cylinder and a lower semi-cylinder, said first fin extending from said upper semi-cylinder and said second fin extending from said lower semi-cylinder.

3. The heat exchanger in accordance with claim 1, wherein said first fin includes a first fin surface and said wall includes an outer surface, said first fin surface substantially tangential to said outer surface.

4. The heat exchanger in accordance with claim 3, wherein said second fin includes a second fin surface, said second fin surface and said outer surface making an angle between about 0° and about 180°.

5. The heat exchanger in accordance with claim 1, wherein said pipe is a first pipe, said heat exchanger further comprising:
a second pipe having a length and comprising a wall defining an interior passageway configured for fluid to flow through;
a third fin disposed on said second pipe and extending from said second pipe wall, said third fin extending in the longitudinal direction along said second pipe; and
a fourth fin disposed on said second pipe and extending from said second pipe wall, said fourth fin extending in the longitudinal direction along said second pipe.

6. The heat exchanger in accordance with claim 5, wherein said first pipe is spaced apart in a third direction from said second pipe to define a space therebetween, at least one of said first fin, second fin, third fin, and fourth fin extending into said space.

7. A submersible heat exchanger for transferring heat between fluid and water in an underwater environment, said heat exchanger comprising:
a first set of pipe segments comprising a first pipe segment and a second pipe segment, each of said first pipe segment and said second pipe segment having a length and comprising a wall defining an interior passageway configured for fluid to flow through, said first pipe segment substantially parallel to said second pipe segment;
a first fin disposed on said first pipe segment and extending from said first pipe segment wall, said first fin extending in the longitudinal direction along said first pipe segment; and
a second fin disposed on said second pipe segment and extending from said second pipe segment wall, said second fin extending in the longitudinal direction along said second pipe segment, said second fin substantially parallel to said first fin.

8. The heat exchanger in accordance with claim 7 further comprising:
a second set of pipe segments comprising at least a third pipe segment and a fourth pipe segment, each of said third pipe segment and said fourth pipe segment comprising a wall defining an interior passageway for fluid to flow through, said third pipe segment substantially parallel to said fourth pipe segment;
a third fin disposed on said third pipe segment and extending from said third pipe segment wall, said third fin extending in the longitudinal direction along said third pipe segment; and
a fourth fin disposed on said fourth pipe segment and extending from said fourth pipe segment wall, said fourth fin extending in the longitudinal direction along said fourth pipe segment.

9. The heat exchanger in accordance with claim 8, wherein said first set of pipes segments and said second set of pipe segments form a matrix of pipe segments aligned in a first direction and a second direction, wherein the first direction is substantially perpendicular to the second direction, each pipe segment in said first set of pipe segments aligned in the first direction in a first column, each pipe segment in said second set of pipe segments aligned in the first direction in a second column, said first column spaced apart in the second direction from said second column to define a space therebetween.

10. The heat exchanger in accordance with claim 9, wherein said first pipe segment and said third pipe segment are aligned in the in the second direction.

11. The heat exchanger in accordance with claim 10, wherein said second pipe segment and said fourth pipe segment are aligned in the in the second direction.

12. The heat exchanger in accordance with claim 11 further comprising a fifth fin extending from said first pipe segment wall, said fifth fin extending in the longitudinal direction along said first pipe segment, and a sixth fin extending from said second pipe segment wall, said sixth fin extending in the longitudinal direction along said second pipe segment.

13. The heat exchanger in accordance with claim 11, wherein said matrix of pipe segments is configured such that said first, second, third, and fourth fins extend at least partly into said space between said first and second columns.

14. The heat exchanger in accordance with claim 13 further comprising a fifth fin disposed on said first pipe segment and extending from said first pipe segment wall, said fifth fin extending in the longitudinal direction along said first pipe segment.

15. The heat exchanger in accordance with claim 14, wherein said first pipe segment wall forms a cylinder having a substantially circular cross section, a plane bisecting said cylinder to define an upper semi-cylinder and a lower semi-cylinder, said first fin extending from said upper semi-cylinder and said fifth fin extending from said lower semi-cylinder.

16. The heat exchanger in accordance with claim 15, wherein said first fin includes a first fin surface and said first pipe segment wall includes an outer surface, said first fin surface substantially tangential to said outer surface.

17. A method of transferring heat between fluid and water in an underwater environment using a submersible heat exchanger, said method comprising:
submerging the heat exchanger in the water, the heat exchanger including a first set of pipe segments and a second set of pipe segments;
propelling fluid through the first set of pipe segments, each pipe segment of the first set of pipe segments including a first wall;
propelling fluid through the second set of pipe segments, each pipe segment of the second set of pipe segments including a second wall, the first set of pipe segments and the second set of pipe segments forming a matrix of pipe segments aligned in a first direction and a second direction, each pipe segment of the first set of pipe segments aligned in the first direction in a first column and each pipe segment of the second set of pipe segments aligned in the first direction in a second column, the first column spaced apart in the second direction from the second column to define a space therebetween;
transferring heat from the fluid in the first set and second set of pipe segments to the water; and
channeling heated water into the space between the first and second columns.

18. The method in accordance with claim 17, wherein channeling heated water comprises contacting heated water with a first fin, the first set of pipe segments including a first pipe segment, the first pipe segment first wall having a cylindrical shape bisected by a first plane defining an upper semi-cylinder and a lower semi-cylinder, the first fin extending from the upper semi-cylinder of the first pipe segment.

19. The method in accordance with claim 18, wherein channeling heated water further comprises contacting water with a second fin, the second set of pipe segments including a second pipe segment, the second pipe segment second wall having a cylindrical shape bisected by a second plane defining an upper semi-cylinder and a lower semi-cylinder, the second fin extending from the upper semi-cylinder of the second pipe segment.

20. The method in accordance with claim 19 further comprising contacting unheated water with a third fin extending from the lower semi-cylinder of the first pipe segment and directing a portion of the unheated water towards the first pipe segment.

21. A method of assembling a submersible heat exchanger, the submersible heat exchanger defining a first direction and a second direction, the method comprising:
aligning a first set of pipe segments in the first direction in a first column, aligning a second set of pipe segments in the first direction in a second column, the first and second columns spaced apart in the second direction from each other to define a space therebetween;
aligning the first and second set of pipe segments in the second direction in a plurality of rows;
coupling a first fin to each pipe segment of the first set of pipe segments, the first fin extending at least partially into the space between the first and second columns;
coupling a second fin to each pipe segment of the second set of pipe segments, the second fin extending at least partially into the space between the first and second columns; and
coupling the first set of pipe segments and the second set of pipe segments to an inlet header and to a discharge header.

22. The method in accordance with claim 21 further comprising coupling a third fin to each pipe segment of the first set of pipe segments, the third fin extending generally away from the second column.

23. The method in accordance with claim 22 further comprising coupling a fourth fin to each pipe segment of the second set of pipe segments, the fourth fin extending generally away from the first column.

24. The method in accordance with claim 22, wherein coupling a first fin comprises coupling a first fin to each pipe segment of the first set of pipe segments, the first fins extending in the longitudinal direction along each of the pipe segments in the first set of pipe segments and coupling a third fin comprises coupling a third fin to each pipe segment of the first set of pipe segments, the third fins extending in the longitudinal direction along each of the pipe segments in the first set of pipe segments.

25. A method of transferring heat between fluid and water in an underwater environment using a submersible heat exchanger, said method comprising:
submerging the heat exchanger in the water, the heat exchanger including a pipe, the pipe including a wall, a first fin, and a second fin, the wall defining an interior passageway configured for fluid to flow through;
propelling fluid through the pipe;
contacting water with the first fin to direct the water towards the pipe;
contacting water with the second fin to direct the water away from the pipe; and
transferring heat between the water and the fluid in the pipe through the wall.
